(19) United States
(12) Patent Application Publication
(10) Pub. No.: US 2012/0002726 A1
(43) Pub. Date: Jan. 5, 2012

(54) Method and apparatus for scalable video coding

(75) Inventors: Yannan Wu, Hong Kong (HK); Laifa Fang, Shenzhen (CN); Zhibin Lei, Hong Kong (HK)

(73) Assignee: Hong Kong Applied Science and Technology Research Institute Company Limited, Hong Kong (HK)

(21) Appl. No.: 12/826,690

(22) Filed: Jun. 30, 2010

(51) Int. Cl. H04N 7/26

(52) U.S. Cl. 375/240.15; 375/240.26; 375/E07.078

(57) ABSTRACT

The present invention relates to method and apparatus for scalable video coding. In particular, the present invention describes a scalable video coding method and a layered video representation that achieves better video quality with more efficient bitstream representation and scalability, and yet is compliant with various codec standard from base layer to enhancement layers so that it incurs minimum modification to existing hardware or system deployed in the field.

### TECHNICAL FIELD

The present invention relates generally to video coding, and more particularly, to scalable video coding (SVC).

### BACKGROUND

Scalability is a desirable feature for many multimedia applications, for example, peer-to-peer (P2P) real-time video streaming, multiple-parties video conferencing and point-to-point video conversation. For example, in P2P content streaming, a content provider desires to provide multimedia contents with different quality at different prices, for example, the low-resolution preview version of the multimedia contents may be available for free. Scalability can be measured in terms of spatial scalability, quality scalability, temporal scalability, or even combined scalability which generally refers to a combination of spatial, quality and temporal scalability. Spatial scalability and temporal scalability respectively describe cases in which subsets of the bitstream represent the source content with a reduced picture size (spatial resolution) or frame rate (temporal resolution). Quality scalability describes cases in which the same spatio-temporal resolution as the complete bitstream is provided with a lower fidelity where fidelity is often informally referred to as signal-to-noise ratio (SNR).

The need for scalability also arises in the case of a P2P network where different users may have different performance capabilities depending on factors like data processing power, display ability and network condition. For example, in the case of real-time broadcasting of a video, every user is expected to receive and see at least something for a good user experience. This requires the multimedia applications to be scalable.

Instead of making the video bitstream scalable, a number of video bitstreams at different quality levels may be provided to satisfy various needs or preferences of users as well as to satisfy varying terminal capabilities or network conditions. However, there will be too many independent video data transmissions simultaneously and the efficiency of the users' inbound and outbound bandwidth will not be efficiently used. In other words, the overall video quality received will not be optimal.

Therefore, scalability is an important feature and scalable video coding allows the removal of parts of the video bitstream in order to adapt the video bitstream to various conditions by methods like encoding higher layer (video with higher quality) based on the whole or part of the lower layer (video with lower quality) as disclosed in Y. Cui and K. Nahrstedt, Layered peer-to-peer streaming, Proc. NOSSDAV' 3, Jun. 2003, which is hereby incorporated by reference in its entirety. Different layers represent videos with different qualities to meet various needs.

Video content scalability has already been supported by video coding standards for years. There are many existing tools adopted by standards such as:
1. H.262/MPEG-2 Video, as disclosed in Generic Coding of Moving Pictures and Associated Audio Information Part 2: Video, ITU-T Rec. H.262 and ISO/IEC 13818-2 (MPEG-2 Video), ITU-T and ISO/IEC JTC1, November 1994;
2. H.263, as disclosed in Video Coding for Low Bitrate Communication, ITU-T Rec. H.263, ITU-T, Version 1: November 1995, Version 2: January 1998, Version 3: November 2000;
3. MPEG-4 Visual, as disclosed in Coding of audio-visual object-Part 2: Visual, ISO/IEC 14492-2 (MPEG-4 Visual), ISO/IEC JTC 1, Version 1: April 1999, Version 2: February 2000, Version 3: May 2004 (hereinafter “Coding of AV object-Part 2”); and
4. H.264/MPEG-4 AVC, as disclosed J. Reichel, H. Schwarz, T. Wiegand, G. J. Sullivan and M. Wien, Joint Draft 11 of SVC Amendment, Joint Video Team, Doc. JVT-X201, July 2007.

The above cited documents are hereby incorporated by reference in their entirety.

Various efforts have been directed to scalable video coding. U.S. Pat. No. 6,639,943 describes the FGS encoding of the enhancement layer in scalable video coding, which involves a new encoding and decoding of layered coded video. The base layer is firstly encoded normally. The enhancement layer residual is encoded based on the base layer residual.

U.S. Patent Application 2007/0160133 describes the generation of four bitstreams which allow both spatial and quality scalability. The first and basic bitstream, the base layer, is the 96 Kbps QCIF video. Another bitstream of the same QCIF resolution is also generated with reference to this base layer. The target bitrate of this layer is 192 Kbps. To achieve more visual quality, another bitstream of CIF resolution is also generated. Since its quality may not be good enough due to the bitrate constraints, an additional higher bitrate CIF bitstream is further encoded to achieve the best resolution and SNR quality. This method combines spatial scalability and FGS. However, the resolution enhancement layer still depends on the interpolation of the low resolution layers.

U.S. Patent Applications 2006/0233241 and 2004/0264567 describe using wavelet transform to achieve scalability. This method separates one frame into four sub-frames and uses motion estimation to compress the similarity between them.

U.S. Pat. No. 7,292,635 describes a scalable data coding method with wavelet transform. Filtering is applied on a single image to influence the coding performance rather than providing any scalability.

The above references reveal that some of the existing methods use a 3-D wavelet transform to remove the spatial and temporal similarity as much as possible whilst providing scalability. A further example is disclosed in S. J. Choi and J. W. Woods, Motion-compensated 3-D subband coding of video, IEEE Trans. Image Process, Vol. 8, no. 2, pp. 155-167, February 1999 which is hereby incorporated by reference in their entirety. Some of the existing methods claim to make use of the information in the lower layer including residual, motion information and reconstruct frames as reference to reduce the coding entropy of the higher layer. A further example is disclosed in the Coding of AV object-Part 2.

However, few of the above methods are widely adopted by the industry since their application is very much limited by complexity in implementation. For example, complexity arises because the existing methods require complete modification of the existing codec to support the scalability. Without any modification, the existing scalable video coding methods restrict users using the existing codec to viewing of the base layer only despite the availability of high hardware capability. In fact, in case of the standard H.264, it has been found that it is difficult to adopt scalable video coding to H.264 especially in terms of spatial and quality scalability.

Furthermore, complexity also arises because the existing methods require the encoding and decoding of lower layer frames to be dependent on other lower layer frames. In other words, each low resolution video bitstream cannot be decoded and reconstructed independently.

There remains a need in the art for improved techniques for coding a video with scalability, particularly with a view of the compliance with the existing codec without or with minimal modification.

### SUMMARY OF THE INVENTION

A first aspect of the present invention is to provide as much visual quality and layers as possible for the users equipped with the existing decoders like H.264. The present invention is to provide both spatial scalability and quality scalability without complex modification of the existing codec.

A second aspect of the present invention is to provide a scalable video coding method with high coding efficiency. Unlike the conventional method in which layers with the same resolution but different SNR value are generated using different quantization steps, the present invention generates frames of the same resolution but different SNR value by applying a low pass filter with a sequence dependent cut-off frequency to the frames with high resolution.

A third aspect of the present invention is to provide a scalable video coding method which allows a subset of all the low resolution video packets to be decoded independent of other low resolution video packets. Therefore, the complexity of coding is lowered, and even if there is any corruption or loss of data in other low resolution video packets, such subset of all the low resolution video packets can still be retrieved reliably.

One further aspect is to improve the overall visual quality for the users. For example, the blocking artifact is suppressed by using filtering to remove the detail information rather than using quantization. Better visual quality can also be achieved by allowing the base layer (low resolution, subsampled version of the original frames) to have more contrast because the base layer is used to predict the higher layers which are also known as enhancement layers without relying on an upsampling operation or inverse wavelet transform to combine the base layer information and the enhancement layer information. Therefore, the base layer video resulting from the present invention has more sharpness feature (better video quality) than the base layer video obtained from the existing multi-scale codec methods.

It is also an aspect of the present invention that a method of scalable video coding can provide video streams of several layers to meet various application requirements, and yet maintain the compression efficiency and standard compliancy.

The present invention applies a low pass filter to a high resolution high quality video frame (HRHQ video frame) from an input video to generate a high resolution low quality video frame. The high resolution low quality video frame (HRLQ video frame) is subsampled to generate a plurality of low resolution video frames (LR video frames). The low pass filter has a cut-off frequency higher than an anti-aliasing frequency so that the visual quality is improved by suppressing the blocking artifacts and retaining more information for the low resolution video frames. In the meantime, the cut-off frequency is set within certain limit to avoid the problem that there will be too much aliasing in the low resolution video frames. The low resolution video frames are encoded in a way that is compliant with at least one of the existing codec standards, and one or more of the low resolution video frames references other low resolution video frames.

This work is different from the existing encoding schemes. Current scalable coding methods usually modify the encoders and decoders so that they are no longer standard compliant. The present invention overcomes the constraint that the video decoders like H.264/AVC or MPEG4 do not support the scalability (spatial and quality scalability) and can only get the base layer decoded properly. Therefore, the present invention allows a system to have more layers decoded, including base layer and enhancement layers, while obtaining better quality due to the reduction of blocking artifacts.

The present invention is useful for any multimedia networking application. It is especially powerful for network applications with non-homogeneous conditions, for example, P2P (peer-to-peer) video streaming, P2P file download, and three-screen (mobile devices, PC, and TV) applications. In a P2P application, each user works as a server so that the inbound/outbound bandwidth and PC computation ability vary from user to user. Scalable video content allows the utilization of all the resources more efficiently while providing each user the best possible video quality.

The present invention is also applicable to media content delivery platform across mobile networks or broadband networks, for example, iShare P2P streaming platform for real-time streaming and Video on Demand (VoD). The present invention can provide IPTV applications, Internet video streaming, and multimedia communications applications such as video conferencing, video exchange, and enterprise video servers.

The present invention can also be delivered as individual coding modules to video codec users, e.g. multimedia system developer companies or solution providers.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 depicts a generic device with the capability of scalable video coding in accordance with some embodiments.

FIG. 2 depicts a flowchart of generating LR video frames and HRLQ video frames from a HRHQ video frame during scalable video coding in accordance with some embodiments.

FIG. 3 depicts an illustration of generating LR video frames from a HRLQ video frame in the reduction process in accordance with some embodiments.

FIG. 4 depicts a flowchart of scalable video coding method in accordance with some embodiments.

FIG. 5 depicts an encoding reference relationship between LR video frames in accordance with some embodiments.

FIGS. 6A-6E illustrate the encoding process.

FIG. 7 depicts the transmission of video sequence to users in a network.

### DETAILED DESCRIPTION OF THE INVENTION

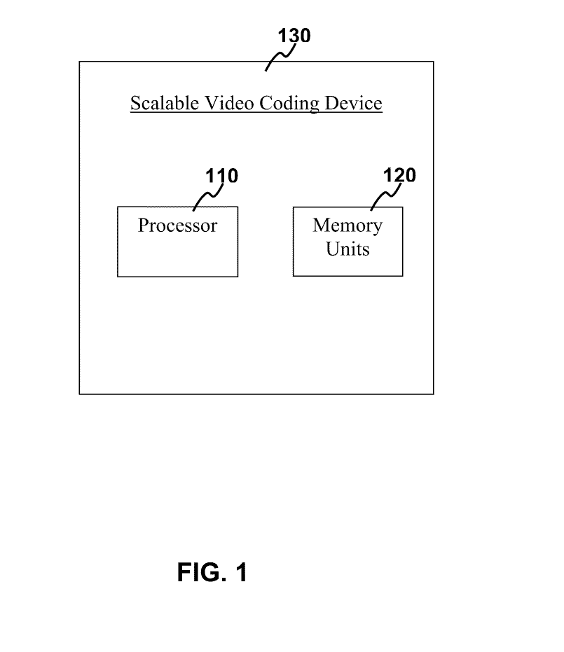

FIG. 1 depicts a generic device with the capability of scalable video coding in accordance with some embodiments of the present invention. The generic device 130 has one or more processors 110 which perform functions such as control and processing. The generic device 130 further includes one or more memory units which store one or more programs. The programs are configured to be executed by the one or more processors 110 and include instructions of scalable video coding methods in accordance with the present invention as disclosed herewith.

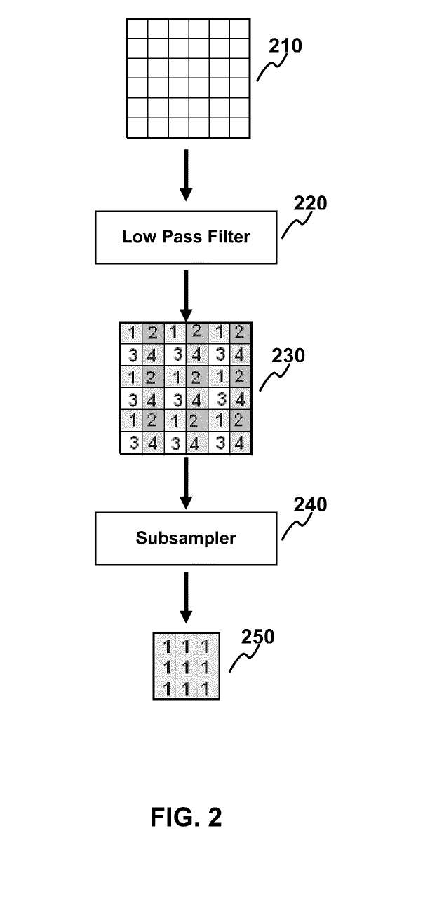

FIG. 2 depicts a flowchart for generating LR video frames and HRLQ video frames from a HRHQ video frame during scalable video coding in accordance with some embodiments. A source video is also known as the high resolution high quality (HRHQ) layer. A HRHQ video frame 210 is a video frame in the HRHQ layer. From the source video, a scalable encoder generates several streams simultaneously. For example, a low pass filter 220 is applied to the HRHQ video frame 210 to generate a high resolution low quality (HRLQ) video frame 230. In one embodiment for a video bitstream with low bitrate, the low pass filter 220 is [1, −2, 0, 8, −10, −20, 74, 154, 74, −20, −10, 8, 0, −2, 1]/256. In one embodiment for a video bitstream with high bitrate, the low pass filter 220 is [1, −2, 0, 8, −10, −20, 74, 154, 74, −20, −10, 8, 0, −2, 1]/256. In one further embodiment for a video bitstream with high bitrate, the low pass filter 220 is not necessary and can be bypassed. The HRLQ video frame 230 is subsampled by a subsampler 240 to generate a set of low resolution (LR) video frames 250, in this example, the members of the set of LR video frames include a LR video frame with pixels labeled with “1”, a LR video frame with pixels labeled with “2”, a LR video frame with pixels labeled with “3” and a LR video frame with pixels labeled with “4”.

At least one LR video bitstream, for example, generated from those LR video frames with pixels labeled with “1” from various time instances, is regarded as the base layer, the encoding result of the LR video frame 250 depends only on other video frames within the LR layer. This base layer can be decoded by any standard compliant decoder without support of scalability. Other LR video bitstreams, for example, the bitstream generated from LR video frames with pixels labeled with “2” from various time instances and the bitstream generated from LR video frames with pixels labeled with “3” from various time instances, are known as enhancement layers. Spatial scalability allows a system to involve at least two layers where the base layer is of lower resolution. After being combined with the enhancement layer information, a video with the same content but higher resolution is constructed. Quality scalability allows a system to involve at least two layers where the base layer is of poorer SNR value. After being combined with the enhancement layer information, a video with the same content and same resolution but better SNR is reconstructed. In some embodiments, one or more additional LR video frames is obtained by reiterating the subsampling process on the existing LR video frames for once or more times. During each subsampling process, a low pass filter may be applied to the video frames which is to be subsampled to limit the bitrate before performing the subsampling.

In one embodiment, both the horizontal and vertical scale factors are 2. Some aliasing is allowed to appear in the LR video frame 250. Therefore, instead of using the anti-aliasing cut-off frequency of lower than or equal to 0.5π, the low pass filter 220 uses a cut-off frequency which is higher than 0.5π. In one embodiment, 0.6π is used as the cutoff frequency of the low pass filter in case of a video bitstream with a low bitrate. In another embodiment, 0.9π is used as the cutoff frequency of the low pass filter in case of a video bitstream with high bitrate. In another embodiment, no low pass filtering is used in the case of a video bitstream with a high bitrate. The cut-off frequency, however, cannot be too high and is kept within a certain limit such that the aliasing effect in the low resolution video frames will not be too significant. For example, in the case of a video bitstream with a high bitrate, the video output will be too blurred if a low pass filter with the cutoff frequency of 0.6 π is used. For example, in the case of a video bitstream with a low bitrate, the video output will be full of blocking artifacts because the bitrate is controlled by the quantization parameter if a low pass filter with the cutoff frequency of 0.9 π is used.

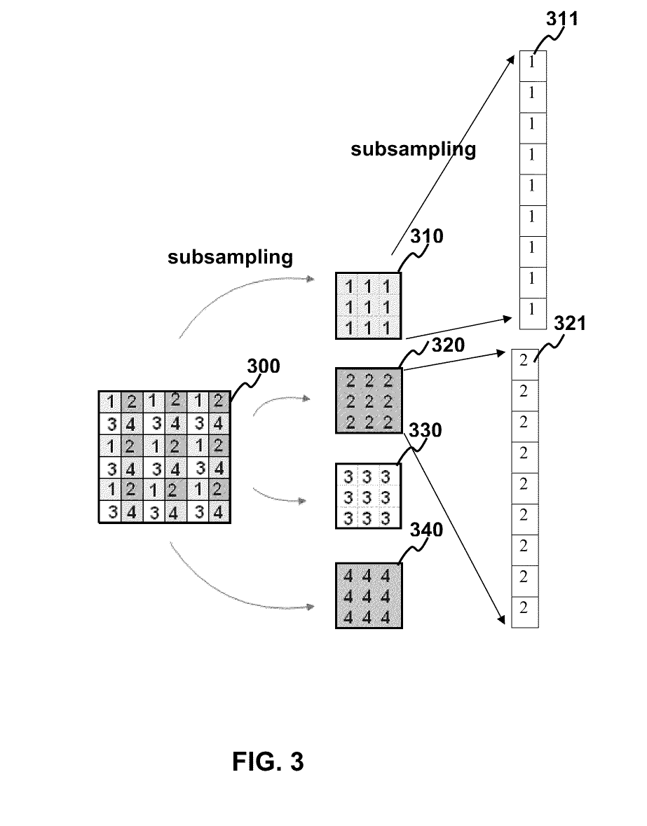

FIG. 3 depicts an illustration in which LR video frames are generated from a HRLQ video frame in subsampling in accordance with some embodiments of the present invention. In one embodiment, both the horizontal and vertical scale factors are 2. Let the resolution of the HRLQ video frame 300 before the subsampling process be A×B, which is 6×6 in this particular example. The HRLQ video frame 300 is divided into 2×2 blocks. Each 2×2 block contains 4 pixels and each pixel is classified into different groups. For illustrative purposes, each pixel from the same group is labeled with the same number. For example, in each 2×2 block in the HRLQ video frame 300, the pixel at the upper left-hand corner is labeled as “1”, the pixel at the upper right-hand corner is labeled as “2”, the pixel at the lower left-hand corner is labeled as “3” and the pixel at the lower right-hand corner is labeled as “4”. The subsampling process is to select all pixels of different groups from every 4×4 block in the HRLQ video frame 300 and group them into a LR video frame. Consequently, the resolution of the LR video frame 310 formed by all the pixels “1” will be A/2×B/2, which is 3×3 in this particular example. Similarly, after subsampling, the LR video frame 320 formed by all the pixels labeled by “2”, the LR video frame 330 formed by all the pixels labeled by “3” and the LR video frame 340 formed by all the pixels labeled by “4” will also have a resolution of A/2×B/2 respectively.

During decoding, if only LR video frame 310 is available for each time instance, the LR video can still be constructed independent of other LR video frames and the high resolution video can also constructed by interpolating the LR video frames 310 only.

Further subsampling and ordering is possible. In some embodiments, the horizontal and vertical scale factors for further subsampling can be any whole number greater than 1 and need not be the same as the scale factors for the previous subsampling. Before the subsampling, a low pass filter may be applied to the LR video frames such as the LR video frames 310, 320, 330, 340. For example, the LR video frame 310 is further subsampled into a number of LR video frames 311 with lower resolution. The ordering of these LR video frames 311 follows the sequence of raster scanning of the LR video frame 310. The LR video frame 320 is further subsampled into a number of LR video frames 321 with lower resolution. The ordering of these LR video frames 321 follows the sequence of raster scanning of the LR video frame 320. Similar process is repeated for the LR video frames 330 and 340. The LR video frames 311 will be encoded, and subsequently the LR video frames 321 will be encoded, so on and so forth.

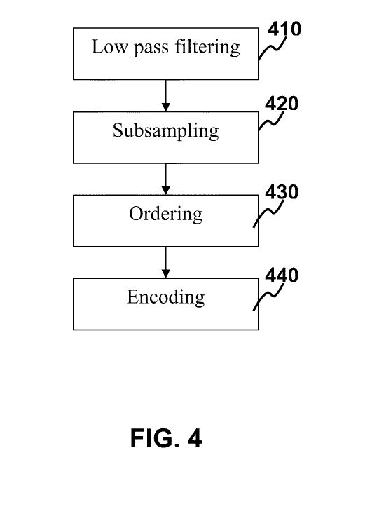

FIG. 4 depicts a flowchart of scalable video coding method in accordance with some embodiments. The scalable video coding method encodes a source video including, as represented by 420, subsampling a high resolution video frame to generate a plurality of low resolution video frames, the number of low resolution video frames ranging from 1 to N, where N is a whole number greater than or equal to 2, each of the N low resolution video frames occurring during each given time instance tᵢ, where i is a whole number ranging from 1 to n with n being the total number of time instances needed for encoding the source video; and as represented by 430, ordering the N low resolution video frames such that the ordinal ranking of any given low resolution video frame in the set of N low resolution video frames remains constant over a time period ranging from t₁ to tₙ. The set of N low resolution video frames is constructed such that during a subsequent decoding of the set of low resolution video frames, a receiving device can select a subset x of the N low resolution frames where x is a whole number ranging from 1 to N for creating a video at the receiving device corresponding to the source video.

For the purposes of the present application, the expression “ordinal ranking” means a particular sequential order of low resolution video frames. For example, as seen in FIG. 3, the ordinal ranking of the first frame would be nominally “1”, the second frame “2”, third frame “3” and fourth frame “4”. When the ordinal ranking of frames 1-4 remains constant over the period of encoding, for each time instance frames 1-4 will always be in the order 1, 2, 3, 4. Of course, it is understood that the number of low resolution video frames ranges from 1 to N where N is a whole number greater than or equal to 2 and tᵢ ranges from 1 to n where n is the total number of time instances for encoding a source video.

The subsampling 420 and the subsequent ordering 430 can be iterated on the low resolution video frames to obtain video frames with even lower resolution such that an additional enhancement layer (those even lower resolution video frames) can be generated in each iteration. More enhancement layers can be obtained by more iterations.

In other words, the scalable video coding method optionally further subsamples each N low resolution video frame to create a set of M low resolution video frames corresponding to each N low resolution video frame where M is a whole number greater than or equal to 2; and ordering the set of M low resolution video frames such that the ordinal ranking of each member of the set of M low resolution video frames remains constant over each time period tᵢ while maintaining the ordinal ranking of the N^{th} low resolution video frame to which the set of M low resolution video frames corresponds. The scalable video coding method optionally further subsamples each of the M low resolution video frames according to the instructions for creating the set of M low resolution video frames.

Before subsampling 420, a low pass filter may be applied to each high resolution video frame to generate a high resolution low quality video frame. For example, if the bitrate of the high resolution video frame is high, it may not be necessary to apply the low pass filter to the high resolution video frame. If the bitrate of the high resolution video frame is low, a low pass filter is applied to the high resolution video frames to enhance the visual quality for the decoded video.

The scalable video coding method encodes the low resolution video as represented by 440, and in one embodiment, the encoding of low resolution video frames is performed in compliance with the existing codec such as H.264 as described below.

The HRLQ layer is also known as the first enhancement layer, or the mid-bitrate layer. The present invention performs encoding in accordance with two main objectives: one is to remove as much redundancy as possible and the other one is to keep the existing codec unchanged. For example, in order to avoid a lot of modification of both the encoder and the decoder, the HRLQ layer is encoded without the following features which are provided by the H.264 scalable extension: the upsampling of the reconstructed low resolution video frames to form the prediction, the prediction of macroblock modes, associated motion parameters, and the residual signal.

As described above in the example of vertical and horizontal scale factors being 2, the HRLQ layer is obtained during the process of generating the LQ layer from the HR layer. Each HRLQ video frame is obtained by applying a low pass filter to the corresponding HR video frame. Since the cut-off frequency of the low pass filter is near 0.5π, there is a lot of redundancy in this video frame. Still, the HRLQ video frame is not recoverable by upsampling of the LR video frame for two reasons:

Firstly, although the cut-off frequency of the low pass filter is set to be around 0.5π, it is impossible for the performance of the low pass filter to be ideal. Consequently, there are still lots of high frequency components in the output of the low pass filter. These high frequency components exist as aliasing in the LR video frame and are not curable by simple upsampling method.

Secondly, the most convenient and fast interpolation methods are in the spatial domain based on polynomials, for example, bicubic interpolation or bilinear interpolations. Such interpolation methods have poor efficiency in the high frequency regions.

Therefore, based on the LR video frame which serves as the base layer, the remaining pixel information is also encoded and transmitted with a view of using the same for reconstruction of that temporal result to serve as the high resolution but poor quality enhancement layer in the present invention.

Unlike the conventional scalable video coding method which upsamples the LR video frame and encodes the difference between the resultant upsampled signal and the HRLQ video frame, the present invention performs the encoding in the following way to fit the HRLQ video frame which is a band limited signal:

Using the example of scale factors equal to 2 as in FIG. 3, the HR video frame at time t is denoted by Pₜ (not shown), the HRLQ video frame which is the output of the low pass filter at time t is denoted by \hat{P}ₜ 300, and the LR video frames which are respectively formed by selecting pixels of the same group from the HRLQ video frame 300 are denoted by \hat{p}_{t,1} 310 for pixels with labeling of “1”, \hat{p}_{t,2} 320 for pixels with labeling of “2”, \hat{p}_{t,3} 330 for pixels with labeling of “3”, and \hat{p}_{t,4} 340 for pixels with labeling of “4”. The video frames are ordered in the following way:

{ . . . . \hat{P}ₜ₋₁, \hat{P}ₜ, \hat{P}ₜ₊₁ . . . } is ordered into:

{ . . . \hat{p}_{t-1,1}, \hat{p}_{t-1,2} \hat{p}_{t-1,3} \hat{p}_{t-1,4} \hat{p}_{t,1} \hat{p}_{t,2} \hat{p}_{t,3} \hat{p}_{t,4} \hat{p}_{t+1,1} \hat{p}_{t+1,2} \hat{p}_{t+1,3} \hat{p}_{t+1,4} . . . }

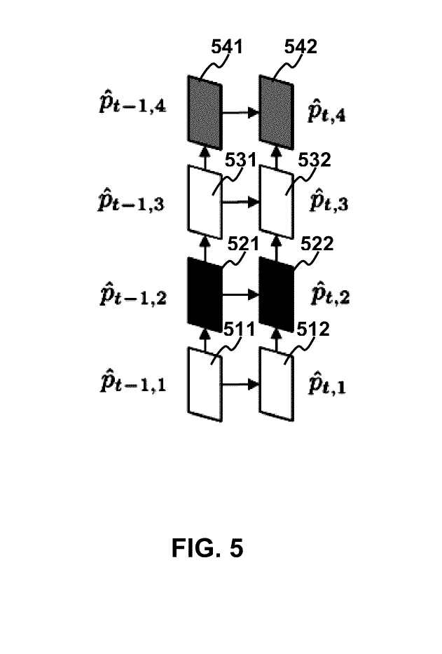

Instead of encoding the sequence of the HRLQ video frames directly, the sequence of the LR video frames in the ordered sequence is encoded. The encoding reference relationship among the LR video frames is illustrated in FIG. 5. The ordered sequence of the LR video frames is encoded with respect to the following encoding reference relationship between the LR video frames in accordance with some embodiments of the present invention:
The LR video frames with pixels labeled by “1” are used as a base layer and known to be base layer video frames, for example, \hat{p}_{t,1} video frame 512 at time t and \hat{p}_{t-1,1} video frame 511 at time t−1. Each base layer frame can use only other base layer frames at different time instances as reference. For example, the \hat{p}_{t,1} video frame 512 can use the \hat{p}_{t-1,1} video frame 511 as reference. If the decoder only receives the base layer frames, it is still possible to reconstruct the low resolution sequence.
Other LR video frames \hat{p}_{t,2} 522, \hat{p}_{t,3} 532, \hat{p}_{t,4} 542 with the labeling of “2”, “3” and “4” respectively are also scalably encoded and generally these LR video frames are known to be enhancement layer frames. In other words, the \hat{p}_{t,1} video frames serve as the base layer, the \hat{p}_{t,2} video frames serve as the first enhancement layer, the \hat{p}_{t,3} video frames serve as the second enhancement layer, and the \hat{p}_{t,4} video frames serve as the third enhancement layer. The LR video frames can only be encoded using one or more other video frames as reference in the layer lower than or equal to its own layer. A first enhancement layer frame is encoded using one or more other first enhancement layer frames, for example, the \hat{p}_{t,2} video frame 522 uses the \hat{p}_{t-1,2} video frame 521 as reference. A second enhancement layer frame is encoded using one or more other second enhancement layer frames, for example, the \hat{p}_{t,3} video frame 532 uses the \hat{p}_{t-1,3} video frame 531 as reference. A third enhancement layer frame is encoded using one or more other third enhancement layer frames, for example, the \hat{p}_{t,4} video frame 542 uses the \hat{p}_{t-1,4} video frame 541 as reference.

In addition, a first enhancement layer frame may also be encoded using one or more base layer frames, for example, the \hat{p}_{t,2} video frame 522 uses the \hat{p}_{t,1} video frame 512 as reference, the \hat{p}_{t-1,2} video frame 521 uses the \hat{p}_{t-1,1} video frame 511 as reference. A second enhancement layer frame may also be encoded using one or more base layer frames and/or one or more other first enhancement layer frames, for example, the \hat{p}_{t,3} video frame 532 uses the \hat{p}_{t,2} video frame 522 and/or the \hat{p}_{t,1} video frame 512 as reference, the \hat{p}_{t-1,3} video frame 531 uses the \hat{p}_{t-1,2} video frame 521 and/or the \hat{p}_{t-1,1} video frame 511 as reference. A third enhancement layer frame may also be encoded using one or more base layer frames, and/or one or more other first enhancement layer frames, and/or one or more second enhancement layer frames, for example, the \hat{p}_{t,4} video frame 542 uses the \hat{p}_{t,3} video frame 532 and/or the \hat{p}_{t,2} video frame 522 and/or the \hat{p}_{t,1} video frame 512 as reference, the \hat{p}_{t-1,4} video frame 541 uses the \hat{p}_{t-1,3} video frame 531 and/or the \hat{p}_{t-1,2} video frame 521 and/or the \hat{p}_{t-1,1} video frame 511 as reference. Consequently, if it is not possible to reconstruct one LR video frame due to packet loss, the LR video frame can still be reconstructed with the help of interpolation unless it is the base layer frames which suffer packet loss.

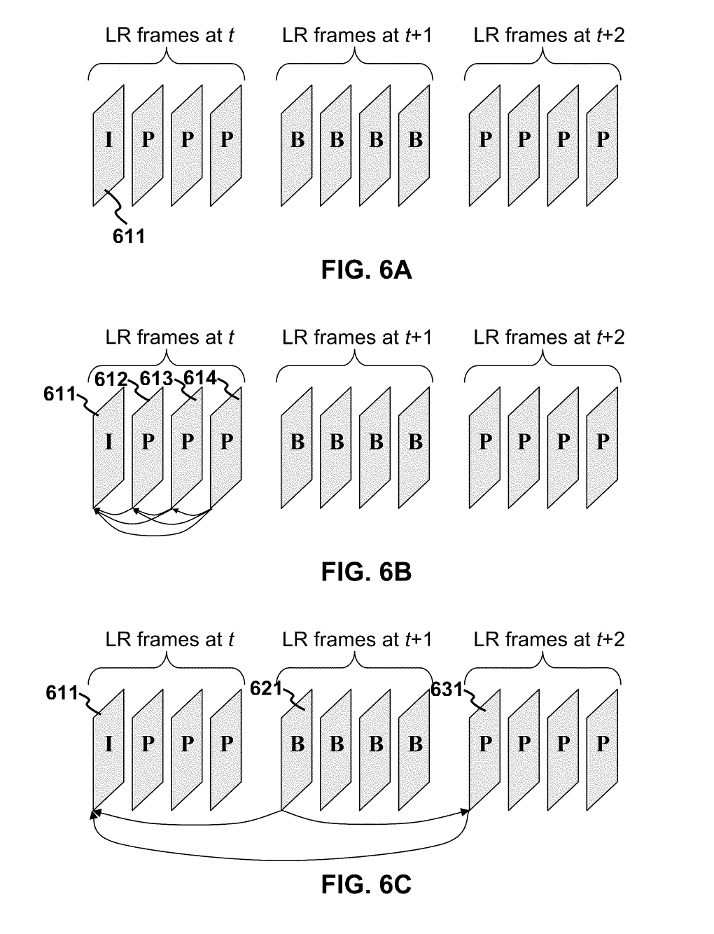

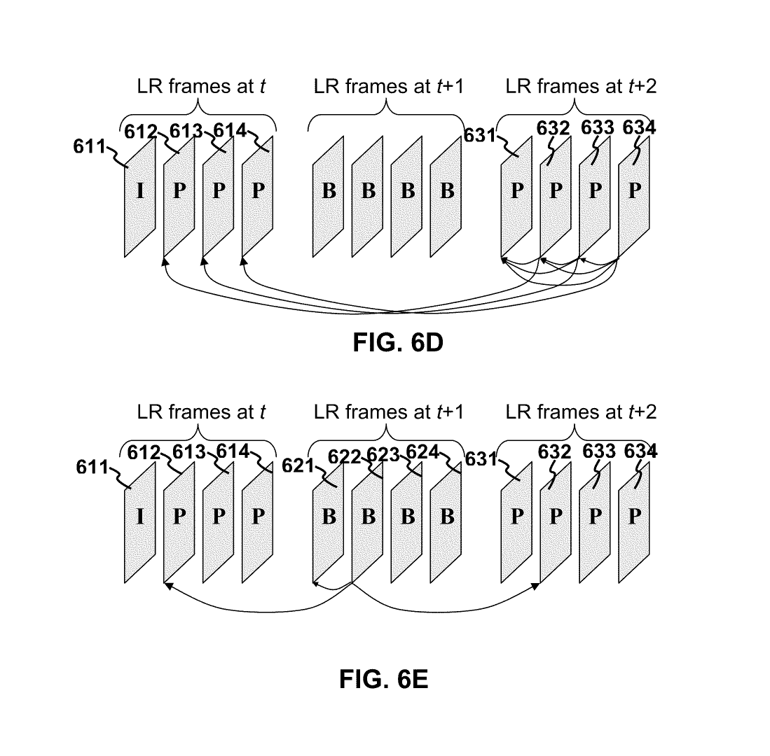

FIGS. 6A-6E illustrate the encoding process. In one embodiment, there are four LR video frames at each time instance. Each LR video frame is a quarter of the HRLQ video frame, and different LR video frames from different time instances are classified according to their spatial arrangement. For example, every LR video frame originating from the upper left corner of the HRLQ video frame is classified as the first LR video frame. Every LR video frame originated from the upper right corner of the HRLQ video frame is classified as the second LR video frame. Every LR video frame originating from the lower left corner of the HRLQ video frame is classified as the third LR video frame. Every LR video frame originating from the lower right corner of the HRLQ video frame is classified as the fourth LR video frame. In a first step, as shown in FIG. 6A, the first LR video frame at time t is encoded as I frame (Independence frame) 611.

In a second step, as shown in FIG. 6B, the second LR video frame at time t is encoded as P frame (Predicted frame) 612, the third LR video frame at time t is encoded as P frame 613 and the fourth LR video frame at time t is encoded as P frame 614. The second LR video frame at time t references the first LR video frame at time t. In other words, the P frame 612 references the I frame 611. The third LR video frame at time t references both the second LR video frame at time t and the first LR video frame at time t. In other words, the P frame 613 references both the P frame 612 and the I frame 611. The fourth LR video frame at time t references the third LR video frame at time t, the second LR video frame at time t and the first LR video frame at time t. In other words, the P frame 614 references the P frame 613, the P frame 612 and the I frame 611. If the information of some the LR video frames at different time instances are lost or corrupted, HRLQ video frames can still be partially reconstructed from the remaining LR video frames. For example, when all the second LR video frames and the third LR video frames at different time instances are lost, it is still possible to reconstruct a half HRLQ video sequence from the first LR video frames and the fourth LR video frames.

In a third step, as shown in FIG. 6C, the first LR video frame at time t+2 is encoded as P frame 631. The first LR video frame at time t+1 is encoded as B frame (Bi-directional predicted frame) 621. Accordingly, given all the first video frames from different time instances, the base layer can be reconstructed.

In a fourth step, as shown in FIG. 6D, the second LR video frame at time t+2 is encoded as P frame 632. The third LR video frame at time t+2 is encoded as P frame 633. The fourth LR video frame at time t+2 is encoded as P frame 634. The second LR video frame at time t+2 references the first LR video frame at time t+2 and the second LR video frame at time t. In other words, the P frame 632 references the P frame 631 and the P frame 612. The third LR video frame at time t+2 references the second LR video frame at time t+2, the first LR video frame at time t+2 and the third LR video frame at time t. In other words, the P frame 633 references the P frame 632, the P frame 631, and the P frame 613. The fourth LR video frame at time t+2 references the third LR frame at time t+2, the second LR video frame at time t+2, the first LR video frame at time t+2, and the fourth LR video frame at time t. In other words, the P frame 634 references the P frame 633, the P frame 632, the P frame 631, and the P frame 614.

In a fifth step, as shown in FIG. 6E, the second LR video frame at time t+1 is encoded as B frame 622. The third LR video frame at time t+1 is encoded as B frame 623. The fourth LR video frame at time t+1 is encoded as B frame 624. The second LR video frame at time t+1 references the first LR video frame at time t+1, the second video LR frame at time t and the second LR video frame at time t+2. In other words, the B frame 622 references the B frame 621, the P frame 612 and the P frame 632. The third LR video frame at time t+1 references the second LR video frame at time t+1, the first LR video frame at time t+1, the third LR video frame at time t and the third LR video frame at time t+2. In other words, the B frame 623 references the B frame 632, the B frame 631, the P frame 633 and the P frame 613. The fourth LR video frame at time t+1 references the third LR video frame at time t+1, the second LR video frame at time t+1, the first LR video frame at time t+1, the fourth LR video frame at time t and the fourth LR video frame at time t+2. In other words, the B frame 644 references the B frame 633, the B frame 632, the B frame 631, the P frame 614 and the P frame 634.

In some embodiments, one or more additional high resolution high quality (HRHQ) layers may also be transmitted to the decoder to provide one or more additional layers. For example, for 1 frames, an additional HRHQ layer is transmitted to the to the decoder. The reconstructed high resolution low quality (HRLQ) frame is subtracted from the high resolution frame. The difference is further encoded as the first I frame and the reconstruction of the difference plus the reconstructed HRLQ frame video is also the reconstruction of the high resolution frame.

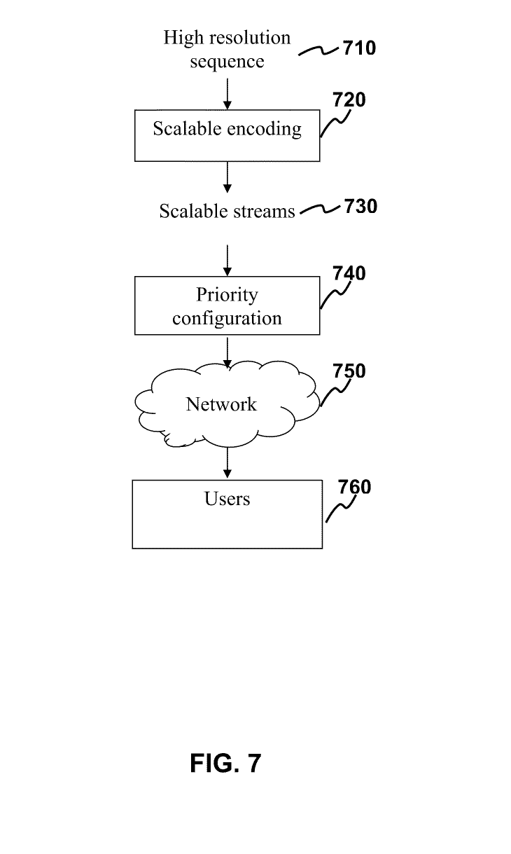

FIG. 7 depicts the transmission of video sequence to users in a network. In a network 750, such as a P2P network, there are many users 760 and each user 760 may have different capabilities. Their capabilities vary due to factors such as variations in the network condition and different computing power of each user 760. Therefore, the transmission of a video sequence needs to fit different users. The video to be transmitted is a high resolution (HR) video sequence 710. Scalable encoding is applied to the HR video sequence 710 to convert the HR video sequence 710 into a number of scalable video streams 730. The scalable video streams 730 are further processed with priority configuration 740. The priority configuration 740 assigns various priorities to the packets by labeling each packet with different priorities. Users 760 with high bandwidth or computing power can access video content of the highest quality by selectively receiving packets of priority 1, 2, 5, 6. Users 760 with less abundant bandwidth or computing power can access video content of lower quality by selectively receiving packets of priority 1, 2, 3, 4. Users 760 with very few bandwidth or computing power can access video content of lower quality by selectively receiving packets of priority 1, 2.

Furthermore, better error concealment method is also applicable in the present invention due to the spatial similarity of the four LR frames. In one embodiment, at the encoder side, the high resolution video frames (HR video frames) are subsampled into a number of smaller video frames. Among those smaller video frames, there is at least one set of smaller video frames which is self-decodable. But when the smaller video frames other than the self-decodable ones are received at the decoder side, these video frames can be used to enhance the quality of the self-decodable ones using certain error concealment methods.

The HR video frames are smoothed by the low pass filter which has a cut-off frequency of 0.5π in the case that scale factors are equal to 2. If the low pass filter is ideal, the LR video frames of only one group of pixels such as the \hat{p}_{t,1} frames are able to carry all the low frequency information. It is not necessary to use the LR video frames of other groups of pixels for the reconstruction of the HRLQ video frames. As it is desirable to have a better quality for the HRLQ video frames, the cut-off frequency of the low pass filter is selected to be higher than 0.5π to retain more information in the HRLQ layer and the LR video frames of other groups of pixels will become more useful for the reconstruction of the HRLQ video frames. However, the cut-off frequency of the low pass filter cannot be too high, going far beyond 0.5π, because there will be too much aliasing in the LR video frames and aliasing will adversely affect the coding performance as aliasing behaves like noise.

The above considerations can be taken into account for selection of the cut-off frequency of the low pass filter, although the cut-off frequency remains quite dependent on the video quality. Moreover, for some sequences captured by cameras with poor quality it is even possible to apply no filtering operation to them since the high frequency information may already have been removed by the capture device. The filtering operation may also be unnecessary for videos which are already compressed at a middle bitrate because such compression serves as a sort of filtering as well.

If the visual quality of the HRLQ layer is not high enough, another HR layer can be generated based on the existing layers. Existing methods can be used such as those disclosed in A. Segall and G. J. Sullivan, Spatial scalability, IEEE Trans. Circuits System Video Technology, vol. 17, no. 9, pp. 1121-1135, September 2007, and D. Marpe H. Schwarz and T. Wiegand, SVC Core Experiment 2.1: Inter-Layer Prediction of Motion and Residual Data, ISO/IEC JTC 1/SC 29/WG 11, Doc. M11043, June 2004, which are incorporated hereby by reference in their entirety.

Furthermore, if the original video sequence does not have too much content, filtering operation is necessary to be applied to the video frames. Therefore, the video quality may be preserved and the HRLQ layer will serve as the HR layer. The above-identified three layer scalable streaming system will shrink to a two layer resolution scalable one.

Embodiments of the present invention may be implemented in the form of software, hardware, application logic or a combination of software, hardware and application logic. The software, application logic and/or hardware may reside on integrated circuit chips, modules or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory computer-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit).

Apparatus or devices which are described in this specification can be implemented by a programmable processor, a computer, a system on a chip, or combinations of them, by operating on input date and generating output. Apparatus or devices can include special purpose logic circuitry, e.g., an FPGA (field programmable gate array) or an ASIC (application-specific integrated circuit). Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Processors suitable for the execution of a computer program include, for example, both general and special purpose microprocessors, and any one or more processors of any kind of digital computer. Generally, a processor will receive instructions and data from a read-only memory or a random access memory or both. The elements of a computer generally include a processor for performing or executing instructions, and one or more memory devices for storing instructions and data.

Computer-readable medium as described in this specification may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. Computer-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Embodiments and/or features as described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with one embodiment as described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The whole specification contains many specific implementation details. These specific implementation details are not meant to be construed as limitations on the scope of the invention or of what may be claimed, but rather as descriptions of features specific to particular embodiments of the invention.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims.

Certain functions which are described in this specification may be performed in a different order and/or concurrently with each other. Furthermore, if desired, one or more of the above-described functions may be optional or may be combined.

The above descriptions provide exemplary embodiments of the present invention, but should not be viewed in a limiting sense. Rather, it is possible to make variations and modifications without departing from the scope of the present invention as defined in the appended claims.

What is claimed is:

1. A scalable video coding device, comprising:
one or more processors;
one or more memory units; and
one or more programs, wherein the one or more programs are stored in the one or more memory units and configured to be executed by the one or more processors, the programs including:
instructions for encoding a source video including subsampling a high resolution video frame to generate a plurality of low resolution video frames, the number of low resolution video frames ranging from 1 to N, where N is a whole number greater than or equal to 2, each of the N low resolution video frames occurring during each given time instance tᵢ, where i is a whole number ranging from 1 to n with n being the total number of time instances needed for encoding the source video; and
instructions for ordering the N low resolution video frames such that the ordinal ranking of any given low resolution video frame in the set of N low resolution video frames remains constant over a time period ranging from t₁ to tₙ;
the set of N low resolution video frames being constructed such that during a subsequent decoding of the set of low resolution video frames, a receiving device can select a subset x of the N low resolution frames where x is a whole number ranging from 1 to N for creating a video at the receiving device corresponding to the source video.

2. The scalable video coding device according to claim 1 further comprising:
instructions for further subsampling each N low resolution video frame to create a set of M low resolution video frames corresponding to each N low resolution video frame where M is a whole number greater than or equal to 2; and
instructions for ordering the set of M low resolution video frames such that the ordinal ranking of each member of the set of M low resolution video frames remains constant over each time period tᵢ while maintaining the ordinal ranking of the N^{th} low resolution video frame to which the set of M low resolution video frames corresponds.

3. The scalable video coding device according to claim 2 further comprising:
instructions for further subsampling each of the M low resolution video frames according to the instructions for creating the set of M low resolution video frames.

4. The scalable video coding device according to claim 1 further comprising:
instructions for applying a low pass filter to the high resolution frame before subsampling.

5. The scalable video coding device according to claim 2 further comprising:
instructions for applying a low pass filter to each N low resolution video frames before subsampling.

6. The scalable video coding device according to claim 3 further comprising:
instructions for applying a low pass filter to each M low resolution video frames before subsampling.

7. The scalable video coding device according to claim 1 further comprising:
instructions for encoding one or more N low resolution video frames by referencing other members of the set of N low resolution video frames.

8. The scalable video coding device according to claim 7, wherein:
at least one N low resolution video frame is encoded as an independent frame such that no reference is made during encoding for the independent frame.

9. The scalable video coding device according to claim 7, wherein:
at least one N low resolution video frame is encoded as a predicted frame such that the predicted frame references to other members of the set of N low resolution video frames.

10. The scalable video coding device according to claim 7, wherein:
at least one N low resolution video frame is encoded as a bi-directional predicted frame such that the bi-directional predicted frame references to other members of the set of N low resolution video frames.

11. A scalable video coding method comprising:
encoding a source video including subsampling a high resolution video frame to generate a plurality of low resolution video frames, the number of low resolution video frames ranging from 1 to N, where N is a whole number greater than or equal to 2, each of the N low resolution video frames occurring during each given time instance tᵢ, where i is a whole number ranging from 1 to n with n being the total number of time instances needed for encoding the source video; and
ordering the N low resolution video frames such that the ordinal ranking of any given low resolution video frame in the set of N low resolution video frames remains constant over a time period ranging from t₁ to tₙ;
the set of N low resolution video frames being constructed such that during a subsequent decoding of the set of low resolution video frames, a receiving device can select a subset x of the N low resolution frames where x is a whole number ranging from 1 to N for creating a video at the receiving device corresponding to the source video.

12. The scalable video coding method according to claim 11 further comprising:
further subsampling each N low resolution video frame to create a set of M low resolution video frames corresponding to each N low resolution video frame where M is a whole number greater than or equal to 2; and
ordering the set of M low resolution video frames such that the ordinal ranking of each member of the set of M low resolution video frames remains constant over each time period tᵢ while maintaining the ordinal ranking of the N^{th} low resolution video frame to which the set of M low resolution video frames corresponds.

13. The scalable video coding method according to claim 12 further comprising:
further subsampling each of the M low resolution video frames according to the instructions for creating the set of M low resolution video frames.

14. The scalable video coding method according to claim 11 further comprising:
applying a low pass filter to the high resolution frame before subsampling.

15. The scalable video coding method according to claim 12 further comprising:
applying a low pass filter to each N low resolution video frames before subsampling.

16. The scalable video coding method according to claim 13 further comprising:
applying a low pass filter to each M low resolution video frames before subsampling.

17. The scalable video coding method according to claim 11 further comprising:
instructions for encoding one or more N low resolution video frames by referencing other members of the set of N low resolution video frames.

18. The scalable video coding method according to claim 17, wherein:
at least one N low resolution video frame is encoded as an independent frame such that no reference is made during encoding for the independent frame.

19. The scalable video coding method according to claim 17, wherein:
at least one N low resolution video frame is encoded as a predicted frame such that the predicted frame references to other members of the set of N low resolution video frames.

20. The scalable video coding method according to claim 17, wherein:
at least one N low resolution video frame is encoded as a bi-directional predicted frame such that the bi-directional predicted frame references to other members of the set of N low resolution video frames.
